(19) United States
(12) Patent Application Publication
(10) Pub. No.: US 2008/0026326 A1
(43) Pub. Date: Jan. 31, 2008

(54) Method of producing thin film magnetic head

(75) Inventor: Masanori Akie, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/542,565

(22) Filed: Oct. 3, 2006

(30) Foreign Application Priority Data
Jun. 26, 2006 (JP) 2006-174872

(51) Int. Cl. G03C 5/00

(52) U.S. Cl. 430/311

(57) ABSTRACT

The method of producing a thin film magnetic head is capable of flattening a surface of a hard bias film without badly influencing a read-element. The method comprises the steps of: forming a magnetoresistance effect film on a wafer substrate; forming a resist layer, at a position corresponding to a read-element of the thin film magnetic head, on the magnetoresistance effect film; forming the read-element by removing a part of the magnetoresistance effect film which is exposed from the resist layer; forming an insulating film so as to coat side faces of the read-element; forming a hard bias film on the insulating film by sputtering; and etching a surface of the hard bias film by ion beam etching so as to flatten the surface thereof.

### BACKGROUND OF THE INVENTION

The present invention relates to a method of producing a thin film magnetic head, in which thin films, e.g., magnetic film, are layered on a wafer substrate.

These days, various types of thin film magnetic heads, each of which includes a read-element constituted by a magnetoresistance effect element, e.g., tunnel junction element (TMR), have been developed. The thin film magnetic heads are assembled in magnetic disk drive units.

A conventional method of producing a thin film magnetic head will be explained with reference to FIGS. 4A-4D and 5E-5G.

In FIG. 4A, a lower shielding layer 84 is formed on a wafer substrate 82. Note that, explanation of a structure between the wafer substrate 82 and the lower shielding layer 84 will be omitted.

Next, a tunnel junction element layer 86 is formed on the lower shielding layer 84.

In FIG. 4B, a resist layer 88 is formed, at a position corresponding to a read-element of said thin film magnetic head to be formed, on the tunnel junction element layer 86 by a photolithographic method. At that time, the resist layer 88 is constituted by a first sub-layer 88a, which is a lower sub-layer, and a second sub-layer 88b, which is an upper sub-layer. A thickness of the first sub-layer 88a is thinner than that of the second sub-layer 88b.

In FIG. 4C, parts of the tunnel junction element layer 86, which are exposed form the resist layer 88, are removed by ion beam etching, so that the read-element 86a is formed.

In FIG. 4D, an insulating film 90, which coats a surface of the lower shielding layer 84 and side faces of the read-element 86a, is formed.

Next, as shown in FIG. 5E, a hard bias film 92 is formed on the insulating film 90 by sputtering.

In FIG. 5F, the resist layer 88 coating the read-element 86a is removed by applying supersonic vibrations to the wafer substrate 82. At that time, the thickness of the first sub-layer 88a of the resist layer 88 is thinner than that of the second sub-layer 88b, so that the resist layer 88 can be easily broken. Therefore, the resist layer can be suitably removed.

In FIG. 5G, a separating layer 94 is formed on the read-element 86a, which is exposed by removing the resist layer 88, and the hard bias film 92. Further, an upper shielding layer 94 is formed on the separating layer 94.

In the above described conventional method, when the hard bias film 92 is formed by sputtering, it is difficult to stick the film 92 onto side parts of the resist layer 88. So, the hard bias film 92 is made thin in the vicinity of the read-element 86a and made thicker with distance therefrom as shown in FIG. 5E. Therefore, the upper shielding layer 96, which is formed on the hard bias film 92, is formed along a surface of the hard bias film 92, so a surface of the upper shielding layer 96 cannot be flattened as shown in FIG. 5G.

If the surface of the upper shielding layer 96 is not flat, a magnetic wall is formed in the upper shielding layer 96 and noises are included in output signals of the read-element 86a.

In Japanese Patent Gazette No. 11-316919, an upper surface of a hard bias film (a magnetic domain control film) is polished by a chemical-mechanical polishing method so as to flatten the upper surface thereof. By flatting the upper surface, the upper shielding layer can be formed with a uniform thickness, so that forming magnetic walls can be restrained and characteristics of the upper shielding layer can be improved (see paragraphs 0044 and 0047 of the Japanese gazette).

However, the conventional method disclosed in the Japanese gazette has a following problem.

Namely, in the method disclosed in the Japanese gazette, the chemical-mechanical polishing must be performed until an upper face of a read-element (a magnetoresistance effect film) is exposed or performed in a state in which the upper face is exposed. Therefore, the upper face of the read-element is also polished, so that functions and performance of the read-element are badly influenced.

### SUMMARY OF THE INVENTION

The present invention was conceived to solve the above described problems.

An object of the present invention is to provide a method of producing a thin film magnetic head, which is capable of flattening a surface of a hard bias film without badly influencing a read-element.

To achieve the object, the present invention has following structures.

Namely, the method of producing a thin film magnetic head of the present invention comprises the steps of: forming a magnetoresistance effect film on a wafer substrate; forming a resist layer, at a position corresponding to a read-element of the thin film magnetic head, on the magnetoresistance effect film; forming the read-element by removing a part of the magnetoresistance effect film which is exposed from the resist layer; forming an insulating film so as to coat side faces of the read-element; forming a hard bias film on the insulating film by sputtering; and etching a surface of the hard bias film by ion beam etching so as to flatten the surface thereof.

Since the hard bias film is formed by sputtering, it is difficult to stick the hard bias film onto side parts of the resist layer. So, the hard bias film is made thin in the vicinity of the read-element and made thicker with distance therefrom. In the method of the present invention, the hard bias film is etched by ion beam etching. The resist layer acts as a shielding wall against ion beams, so that amount of ion beams colliding with the hard bias film in the vicinity of the resist layer can be reduced. Therefore, a surface of the hard bias film can be flattened. Further, the surface of the hard bias film can be flattened with the resist layer leaving on the read-element, so that the fattening step does not badly influence the read-element. The resist layer for forming the read-element can be used as a resist when the hard bias film is flattened, so that the hard bias film can be flattened without increasing production steps.

The method may further comprise the step of forming a protection film, which is resistant to the etching, on the resist layer so as to restrain the resist layer from etching.

In the method, the protection film may be made of one substance selected from the group consisting of: Al₂O₃, AlN or SiO₂.

In the method, a thickness of the protection film may be 20 nm or less.

By the protection film, the resist layer is not removed by etching while the hard bias film is flattened.

In the method, an incoming direction of ion beams, which are irradiated toward the wafer substrate in the etching step, may be inclined 10 degrees or more with respect to a normal line of a surface of the wafer substrate. In this case, even if etching dusts, which are formed by the etching step, stick onto the side faces of the resist layer again, ion beams collide with the side faces of the resist layer so that the etching dusts can be removed. Therefore, sticking the etching dusts in the vicinity of the read-element can be restrained when the resist layer is removed.

In the method, an incoming direction of ion beams, which are irradiated toward the wafer substrate in the etching step, may be inclined with respect to a normal line of a surface of the wafer substrate, and the wafer substrate may be relatively rotated, with respect to the ion beams, in a plane parallel to the surface of the wafer substrate. In this case, the resist layer acts as a shielding wall, which reduces amount of ion beams colliding with the hard bias film in the vicinity of the resist layer (the read-element), so that amount of etching the hard bias film in the vicinity of the resist layer (the read-element) can be reduced.

In the method, the inclination angle of the incoming direction of ion beams may be varied in the etching step. In this case, flatness of the hard bias film can be suitably controlled.

In the method, a thickness of the resist layer coating the read-element may be 1 μm or less. In this case, the hard bias film can be suitably flattened without reducing amount of etching the hard bias film at positions separated a prescribed distance or more from the resist layer (the read-element).

In the method, he resist layer may be constituted by an upper sub-layer and a lower sub-layer, whose thickness is thinner than that of the upper sub-layer. In this case, the resist layer can be easily removed.

By employing the method of the present invention, the surface of the hard bias film can be flattened without badly influencing the read-element.

### BRIEF DESCRIPTION OF THE DRAWINGS

Embodiments of the present invention will now be described by way of examples and with reference to the accompanying drawings, in which:

FIGS. 1A-1D are partial sectional views showing steps of a method of an embodiment of the present invention;

FIGS. 2E-2H are partial sectional views showing further steps of the method of the embodiment of the present invention;

FIG. 3 is a sectional view explaining an etching step of the method;

FIGS. 4A-4D are partial sectional views showing steps of the conventional method of producing the thin film magnetic head; and

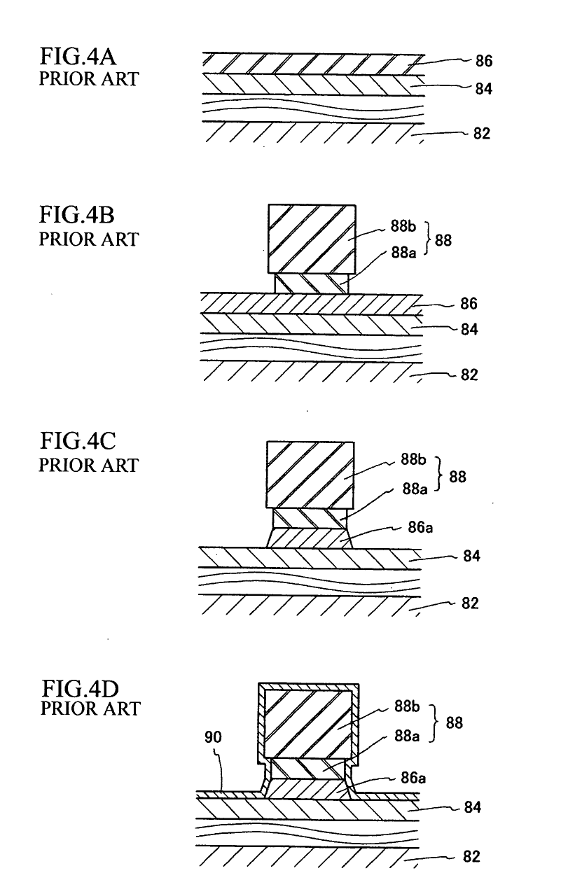

FIGS. 5E-5G are partial sectional views showing further steps of the conventional method.

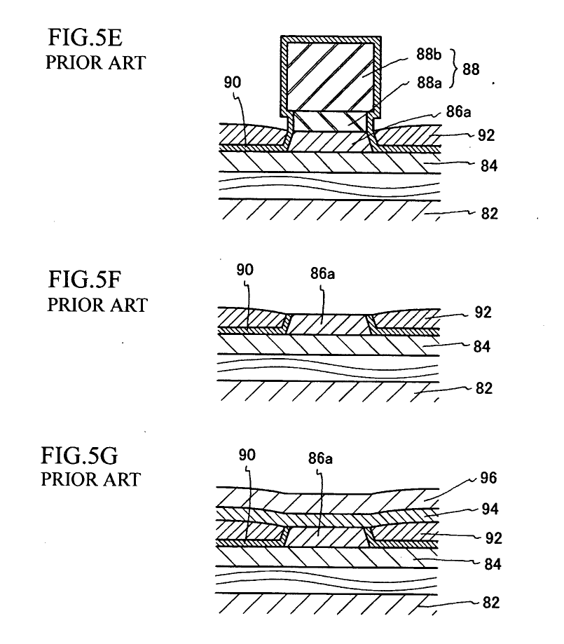

### DETAILED DESCRIPTION OF THE EMBODIMENTS

Preferred embodiments of the present invention will now be described in detail with reference to the accompanying drawings.

The thin film magnetic head of the present embodiment is used for a magnetic disk drive unit and has a read-element constituted by a magnetoresistance effect element, e.g., tunnel junction element (TMR).

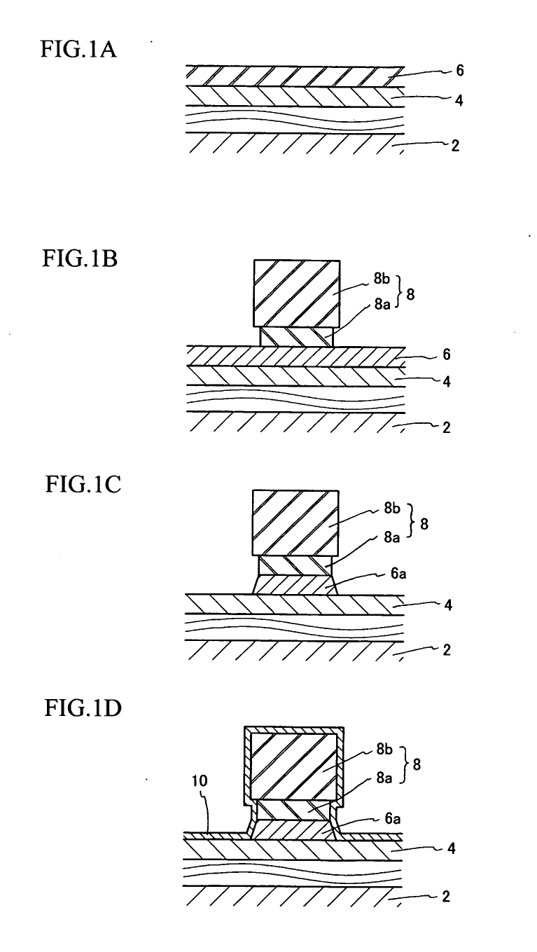

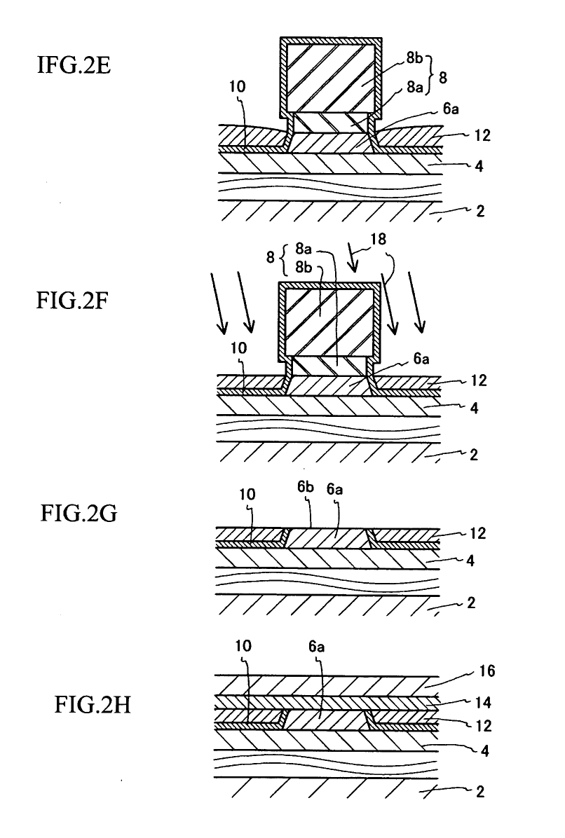

A method of producing the thin film magnetic head of the present embodiment will be explained with reference to FIGS. 1A-1D and FIGS. 2E-2H).

In FIG. 1A, a lower shielding layer 4 is formed on a wafer substrate 2. Note that, explanation of a structure between the wafer substrate 2 and the lower shielding layer 4 will be omitted.

Next, a tunnel junction element layer 6 is formed on the lower shielding layer 4.

In FIG. 1B, a resist layer 8 is formed, at a position corresponding to a read-element of the thin film magnetic head to be formed, on the tunnel junction element layer 6 by a photolithographic method. At that time, the resist layer 8 is constituted by a first sub-layer 8a, which is a lower sub-layer, and a second sub-layer 8b, which is an upper sub-layer. A thickness of the first sub-layer 8a is thinner than that of the second sub-layer 8b. A thickness of the resist layer 8 is 1 μm or less, e.g., 300-400 nm.

In FIG. 1C, parts of the tunnel junction element layer 6, which are exposed form the resist layer 8, are removed by ion beam etching, so that the read-element 6a is formed.

In FIG. 1D, an insulating film 10, which coats a surface of the lower shielding layer 4 and side faces of the read-element 6a, is formed.

At that time, the insulating film 10 coats a surface of the resist layer 8 too. The insulating film 10 coating the resist layer 8 acts as a protection film against etching beams in the following etching step. Namely, the insulating film 10 restrains the resist layer 8 from etching. The insulating film (the protection film) 10 is made of one substance selected from the group consisting of: Al₂O₃, AlN or SiO₂. A thickness of the protection film is 20 nm or less. Note that, a step of forming a protection film, which is resistant to the etching, on the surface of the resist layer 8 may be further added, besides the step of forming the insulating film 10 coating the upper face of the lower shielding layer 4 and the side faces of the read-element 6a.

Next, as shown in FIG. 2E, a hard bias film 12 is formed on the insulating film 10 by sputtering. At that time, it is difficult to stick a sputtered material onto side parts of the resist layer 8. So, the hard bias film 92 is made thin in the vicinity of the read-element 6a and made thicker with distance therefrom.

Next, as shown in FIG. 2F, the surface of the hard bias film 12 is etched by ion beam etching.

In the etching step, the resist layer 8 acts as a shielding wall against ion beams, so that amount of ion beams 18 colliding with the hard bias film 12 in the vicinity of the resist layer 8 (the read-element 6a) can be reduced. Etching the hard bias film 12 is relatively advanced more with distance from the resist layer 8 (the read-element 6a), so that the surface of the hard bias film 12 can be flattened.

At that time, the read-element 6a is coated with the resist layer 8 and is not exposed, so that the read-element 6a is not badly influenced by the flattening process.

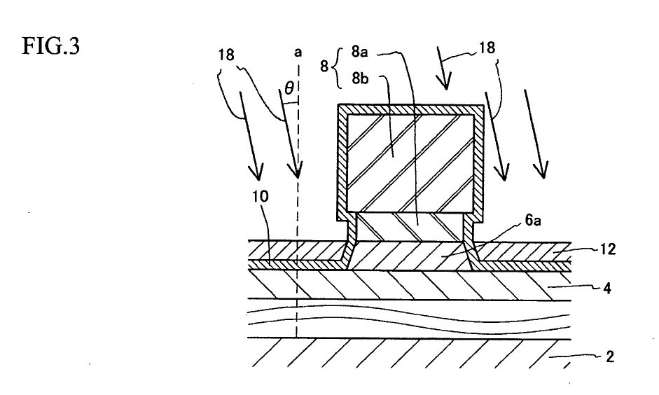

In the etching step, as shown in FIG. 3, an incoming direction of ion beams 18, which are irradiated toward the wafer substrate 2, is inclined with respect to a normal line “a” of a surface of the wafer substrate, which is extended in a stacking direction of the thin films, and the wafer substrate 2 is relatively rotated, with respect to the ion beams 18, in a plane parallel to the surface of the wafer substrate 2. With this process, the resist layer 8 further effectively shields the ion beams 18, so that the amount of ion beams 18 colliding with the hard bias film 12 in the vicinity of the resist layer 8 (the read-element 6a) can be reduced. Therefore, the amount of etching the hard bias film 12 in the vicinity of the resist layer 8 (the read-element 6a) can be reduced.

The incoming direction of the ion beams 18, which are irradiated toward the wafer substrate 2, is inclined with a suitable angle θ, e.g., 10 degrees or more. With this structure, even if etching dusts, which are formed by the etching step, stick onto the side faces of the resist layer 8 again, the ion beams 18 collide with the side faces of the resist layer 8 so that the etching dusts can be removed. Therefore, sticking the etching dusts in the vicinity of the read-element 6a can be restrained when the resist layer 8 is removed in the following step. By removing the etching dusts, no asperities are formed in the surfaces of the hard bias film 12 and the read-element 6a after the resist layer 8 is removed.

Further, the inclination angle θ of the incoming direction of the ion beams 18 may be varied in the etching step so as to control flatness of the hard bias film 12. If the angle θ is wide, the amount of etching the hard bias film 12 can be reduced at a position distant from the resist layer 8. By controlling the inclination angle θ on the basis of an etching position, the amount of etching the hard bias film 12 can be controlled at all positions.

Further, by controlling the thickness of the resist layer 8, the amount of etching the hard bias film 12 can be controlled. With increasing the thickness of the resist layer 8, the amount of etching the hard bias film 12 is reduced not only in the vicinity of the resist layer 8 but also at positions distant therefrom.

According to the study by the inventors, the hard bias film 12 can be suitably flattened when the thickness of the resist layer 8 is 1 μm or less, preferably 300-400 nm.

After etching the hard bias film 12, as shown in FIG. 2G, the resist layer 8 coating the read-element 6a is removed or lifted off by applying supersonic vibrations to the wafer substrate 2. At that time, the thickness of the first sub-layer 8a of the resist layer 8 is thinner than that of the second sub-layer 8b, so that the resist layer 8 can be easily broken. Therefore, the resist layer 8 can be suitably removed.

Next, as shown in FIG. 2H, a separating layer 14, which is made of tantalum or ruthenium, is formed on the read-element 6a, which is exposed by removing the resist layer 8, and the hard bias film 12. Further, an upper shielding layer 16 is formed on the separating layer 14.

At that time, the surface of the hard bias film 12 has been made flat, so that the separating layer 14 and the upper shielding layer 16 can be made flat. Therefore, forming magnetic walls in the upper shielding layer 16 can be restrained, and characteristics of the upper shielding layer 16 can be improved.

Unlike the conventional method, the method of the present embodiment is capable of flattening the surface of the hard bias film 12 without badly influencing the read-element 6a.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of producing a thin film magnetic head, comprising the steps of:
forming a magnetoresistance effect film on a wafer substrate;
forming a resist layer, at a position corresponding to a read-element of said thin film magnetic head, on the magnetoresistance effect film;
forming the read-element by removing a part of the magnetoresistance effect film which is exposed from the resist layer;
forming an insulating film so as to coat side faces of the read-element;
forming a hard bias film on the insulating film by sputtering; and
etching a surface of the hard bias film by ion beam etching so as to flatten the surface thereof.

2. The method according to claim 1,
further comprising the step of forming a protection film, which is resistant to the etching, on the resist layer so as to restrain the resist layer from etching.

3. The method according to claim 2,
wherein the protection film is made of one substance selected from the group consisting of: Al₂O₃, AlN or SiO₂.

4. The method according to claim 2,
wherein a thickness of the protection film is 20 nm or less.

5. The method according to claim 1,
wherein an incoming direction of ion beams, which are irradiated toward the wafer substrate in said etching step, is inclined 10 degrees or more with respect to a normal line of a surface of the wafer substrate.

6. The method according to claim 1,
wherein an incoming direction of ion beams, which are irradiated toward the wafer substrate in said etching step, is inclined with respect to a normal line of a surface of the wafer substrate, and
the wafer substrate is relatively rotated, with respect to the ion beams, in a plane parallel to the surface of the wafer substrate.

7. The method according to claim 5,
wherein the inclination angle of the incoming direction of ion beams is varied in said etching step.

8. The method according to claim 6,
wherein the inclination angle of the incoming direction of ion beams is varied in said etching step.

9. The method according to claim 5,
wherein a thickness of the resist layer coating the read-element is 1 μm or less.

10. The method according to claim 6,
wherein a thickness of the resist layer coating the read-element is 1 μm or less.

11. The method according to claim 1,
wherein the resist layer is constituted by an upper sub-layer and a lower sub-layer, whose thickness is thinner than that of the upper sub-layer.
